(19) United States
(12) Patent Application Publication
(10) Pub. No.: US 2014/0338492 A1
(43) Pub. Date: Nov. 20, 2014

(54) ACCELERATOR PEDAL DEVICE

(71) Applicant: TOYOTA JIDOSHA KABUSHIKI KAISHA, Toyota-shi, Aichi-ken (JP)

(72) Inventors: Yoshimitsu Yokoi, Toyota-shi (JP); Yuko Fukaya, Tokai-shi (JP)

(21) Appl. No.: 14/360,847

(22) PCT Filed: Nov. 26, 2012
(86) PCT No.: PCT/IB2012/002484

§ 371 Date: May 27, 2014

(30) Foreign Application Priority Data
Nov. 28, 2011 (JP) 2011-259299

(51) Int. Cl. G05G 1/44

(52) U.S. Cl. CPC G05G 1/44
USPC 74/513

(57) ABSTRACT

In an accelerator pedal device, a fitted portion of a pedal is inserted into a groove portion of a fitting portion by sliding the fitted portion, and then the fitted portion and the groove portion are fitted to each other. Furthermore, an engagement hook portion of the fitted portion is engaged with an engagement hole. Still further, an upper wall of the bracket contacts a stopper portion of the mount, so that the engagement hole is restrained from being displaced in a direction away from the fitted portion.

### BACKGROUND OF THE INVENTION

1. Field of the Invention

The invention relates to an accelerator pedal device.

2. Description of the Related Art

In an accelerator pedal device described in Japanese Utility Model Application Publication No. 6-12160 (JP 6-12160 U), a support member (mount) is provided on a floor. This support member (mount) is constructed of a pair of spring plates that form a fit-in opening and a fit-in portion.

Then, a shaft portion of the accelerator pedal is pressed in to the fit-in portion side from the fit-in opening. As a result, the spring plates elastically deform so that the shaft portion is engaged with the fit-in portion. On the other hand, the shaft portion engaged with the fit-in portion is drawn to the fit-in opening side. As a result, the spring plates elastically deform so that the shaft portion is detached from the fit-in portion (the engagement between the shaft portion and the fit-in portion is released). Thus, the accelerator pedal can easily be attached and detached.

However, as for the above-described accelerator pedal device, there is a possibility of the shaft portion slipping off from the fit-in portion due to deterioration of the engagement force that the fit-in portion has on the shaft portion and time-dependent deformation of the spring plates. Therefore, a support structure of an accelerator pedal as described above has a room for improvement in terms of restraining the accelerator pedal from slipping off from the support member (mount).

### SUMMARY OF THE INVENTION

The invention provides an accelerator pedal device capable of restraining the pedal from slipping off from the mount.

An accelerator pedal device in accordance with an aspect of the invention includes: a bracket provided on a floor on which a driver's seat of a vehicle is disposed; a mount including a fitting portion extending in a vehicle width direction and having an annular shape a part of which is open when reviewed from a side direction of the vehicle, and a first engagement portion provided in the fitting portion, and the mount being assembled to the bracket; a pedal including a fitted portion that is fitted to the fitting portion by sliding the fitted portion toward one side in the vehicle width direction, and an engaged portion that is provided in the fitted portion and that restricts movement of the fitted portion toward another side in the vehicle width direction by engaging with the first engagement portion, the pedal being applied with depression force; and a restraint portion that contacts the fitting portion and restrains the first engagement portion from being displaced in a direction away from the fitted portion.

Therefore, the pedal can be restrained from slipping off from the mount.

The accelerator pedal device in accordance with the foregoing aspect of the invention may be configured so that the restraint portion is provided on the bracket.

Therefore, the restraint portion can be efficiently provided.

In the accelerator pedal device in accordance with the aspect of the invention, the bracket may have a hat shape in a cross section when reviewed from a side direction of the vehicle.

Therefore, the mount can be caused to contact the bracket that has high rigidity so that displace of the engagement portion can be restrained.

The accelerator pedal device in accordance with the aspect of the invention may further include a protrusion portion that is provided on the mount and protrudes toward the restraint portion and that is configured to be able to contact the restraint portion.

Therefore, the mount can be caused to contact the restraint portion corresponding to the distance between the restraint portion and the mount.

In the accelerator pedal device in accordance with the aspect of the invention, the protrusion portion may be provided on the fitting portion.

In the accelerator pedal device in accordance with the aspect of the invention, the fitting portion may include a contact portion that contacts an end portion of the fitted portion which is at the one side in the vehicle transverse direction, and the one side in the vehicle transverse direction is rightward of the vehicle.

Therefore, the pedal can be restrained from being caused to slip off from the mount by force input to the pedal.

The accelerator pedal device in accordance with the aspect of the invention may further include a second engagement portion provided on the mount and configured to be able to engage with the bracket.

Therefore, ease of assembling the mount to the bracket can be improved.

In the accelerator pedal device in accordance with the aspect of the invention, the second engagement portion may include a claw portion that is able to engage with the bracket when inserted in the bracket.

In the accelerator pedal device in accordance with the aspect of the invention, the mount may also be configured to be fastened to the bracket by at least two fastening members.

Therefore, the ease of assembling the mount to the bracket can be further improved.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a sectional view showing a state in which a fitted portion of a pedal for use in an accelerator pedal device in accordance with an embodiment of the invention is fitted to a groove portion of a mount (a sectional view taken along line I-I of FIG. 2);

FIG. 2 is a perspective view showing the accelerator pedal device shown in FIG. 1;

FIG. 3 is a perspective view showing a dissembled state of the accelerator pedal device shown in FIG. 2;

FIG. 4 is a back view of the accelerator pedal device shown in FIG. 2 which is viewed from a back surface side of the mount;

FIG. 5 is a side sectional view showing the accelerator pedal device shown in FIG. 2 (a sectional view taken on line V-V of FIG. 2);

FIG. 6 is a sectional view showing a state in which an engagement claw portion of the mount used in the accelerator pedal device shown in FIG. 4 has been inserted in a positioning hole of a bracket (a sectional view taken on line VI-VI of FIG. 4); and

FIG. 7 is a sectional view showing a state in which the mount for use in the accelerator pedal device shown in FIG. 2 is fastened to the bracket (a sectional view taken on line VII-VII of FIG. 2).

### DETAILED DESCRIPTION OF EMBODIMENTS

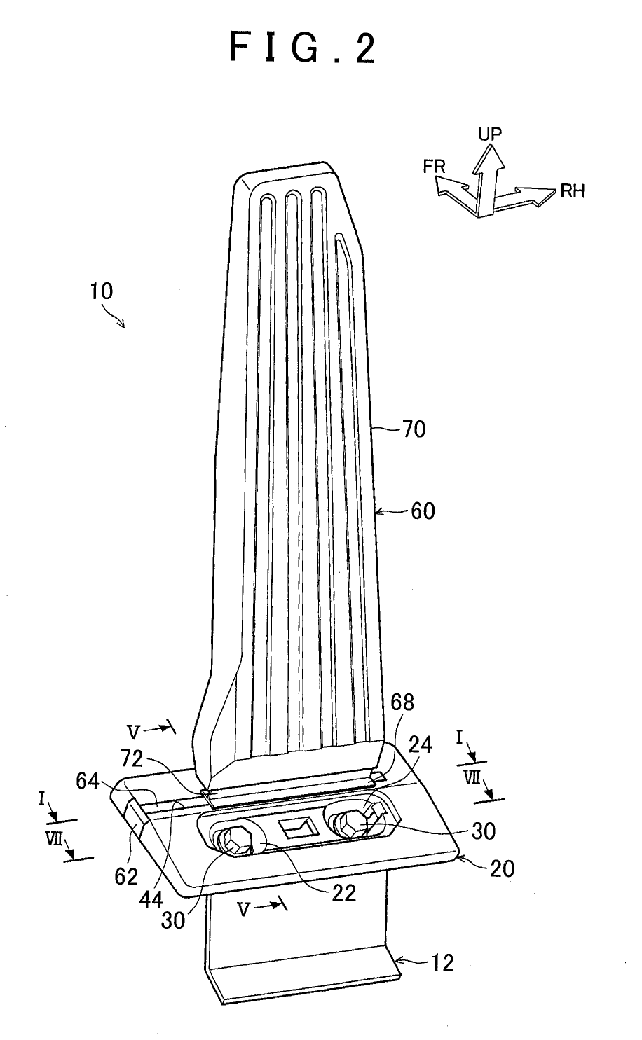

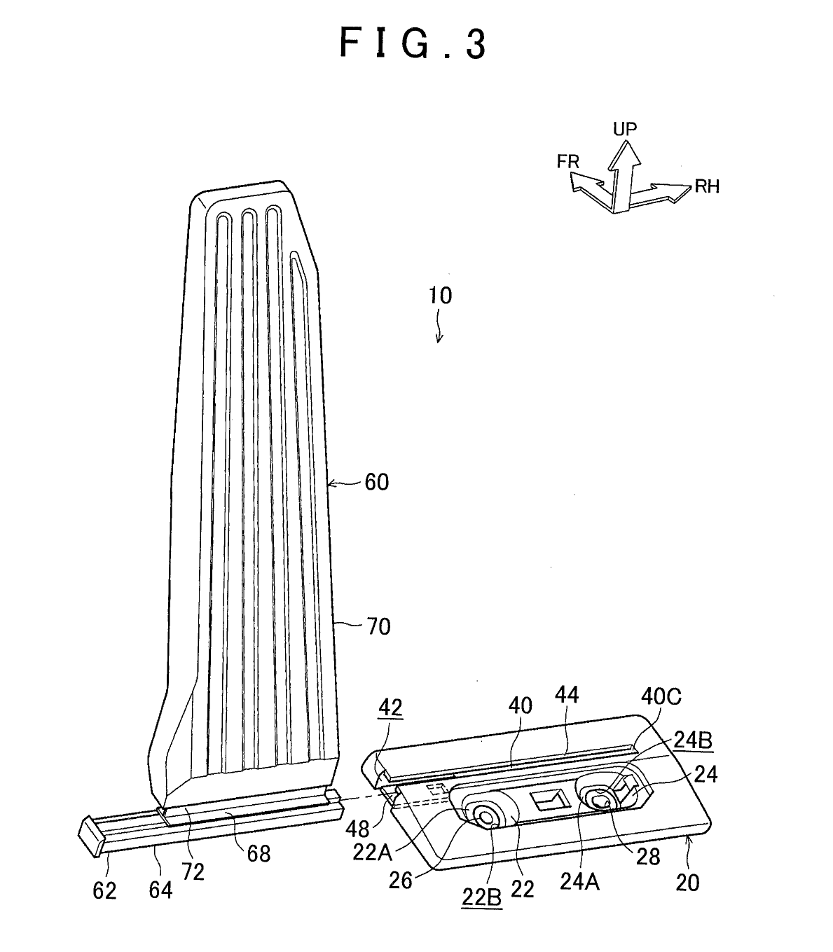

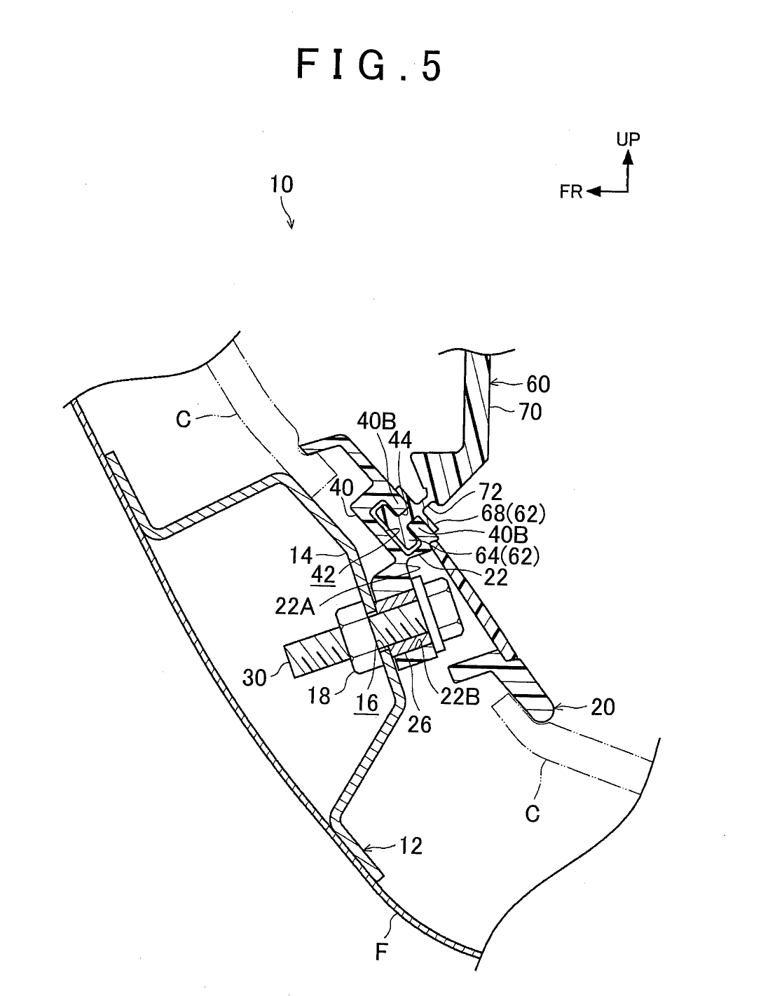

FIG. 2 shows the whole of an accelerator pedal device 10 in accordance with an embodiment of the invention in a perspective view. FIG. 3 shows a disassembled state of the accelerator pedal 10 in a perspective view. Furthermore, FIG. 5 shows the accelerator pedal device 10 in a sectional view taken from a leftward direction of the vehicle. It is to be noted that arrows FR appropriately shown in the drawings indicate the forward direction of the vehicle. An arrow RH shows a rightward direction of the vehicle (a direction to one of the sides in the vehicle width direction). An arrow UP indicates an upward direction of the vehicle.

As shown in FIGS. 2, 3 and 5, the accelerator pedal device 10 includes a bracket 12, a mount 20 and a pedal 60. The bracket 12 is fixed to a floor F on which a driver's seat of the vehicle is provided. The mount 20 is fastened (assembled) to the bracket 12. The pedal 60 is supported on the mount 20. It is to be noted that in FIG. 3, illustration of the bracket 12 is omitted.

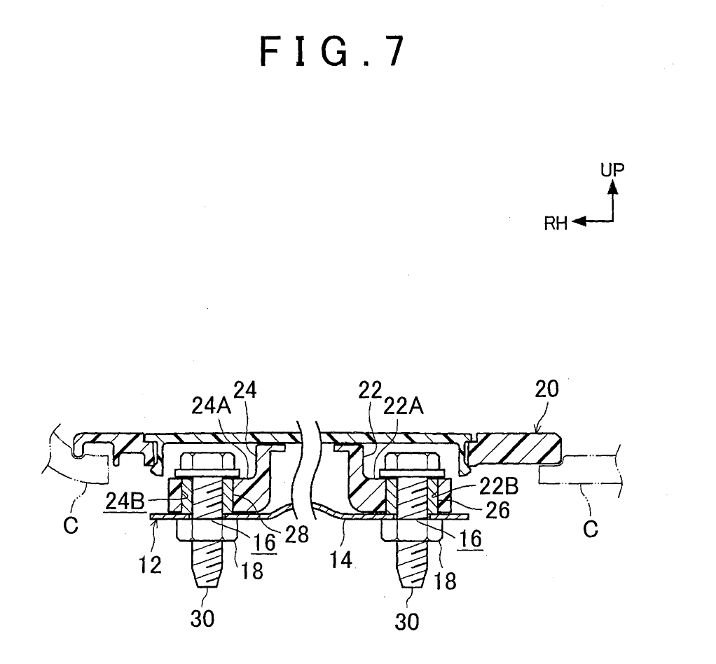

As shown in FIG. 5, the bracket 12 is made of a metal sheet. Furthermore, the bracket 12 is formed in a hat shape in a side view. That is, the bracket 12 has a rectangular wave like cross-sectional configuration in a side view of the vehicle. The bracket 12 is disposed with an inclination such as to extend obliquely in a forward-upward direction of the vehicle (such that a forward side of the bracket 12 is located above a rearward side of the bracket 12). As shown also in FIG. 7, an upper wall 14 of the bracket 12 is provided with a pair of fastening holes 16 for fastening the mount 20 (described later). The fastening holes 16 are arranged in the vehicle width direction. Furthermore, a pair of nuts 18 are fixed by welding or the like to an back surface-side portion (a portion at the floor F side of the vehicle) of the upper wall 14 of the bracket 12. The nuts 18 are disposed coaxially with the pair of fastening holes 16.

The mount 20 is manufactured of a resin (e.g., PA (polyamide) containing glass fiber), and is formed in a generally rectangular platy shape. Furthermore, the mount 20 is provided at a vehicle cabin side of the bracket 12 (a side opposite the floor F of the vehicle). The mount 20 is disposed facing the upper wall 14 of the bracket 12. Thus, the mount 20 is disposed with an inclination such as to extend in a forward-upward oblique direction of the vehicle in a side view (such that a forward side of the mount 20 is located above a rearward side thereof).

As shown in FIGS. 3, 4 and 7, a substantially central portion of the mount 20 is provided with a pair of recess portions 22 and 24 that correspond to the fastening holes 16 of the bracket 12. The recess portions 22 and 24 are projected to the bracket 12 side. Bottom walls 22A and 24A of the recess portions 22 and 24 are disposed parallel to the upper wall 14 of the bracket 12.

The bottom wall 22A of the recess portion 22 provided at the left side of the vehicle is provided with a circular fit-in hole 22B. A first collar 26 made of a metal and having a hollow circular cylindrical shape is fitted in the fit-in hole 22B. The first collar 26 is disposed coaxially with the fastening hole 16 of the bracket 12. The height dimension of the first collar 26 is set slightly greater than the thickness dimension of the bottom wall 22A. The first collar 26 is slightly protruded from the bottom wall 22A to the bracket 12 side, and contacts the upper wall 14 of the bracket 12.

Furthermore, a bottom wall 24A of the recess portion 24 at the right side of the vehicle is provided with a fit-in hole 24B having a generally oval shape. A second collar 28 made of a metal and having a hollow cylindrical shape with a generally oval shape in cross section is fitted in the fit-in hole 24B. The second collar 28 is disposed coaxially with the fastening hole 16 of the bracket 12. The height dimension of the second collar 28 is set slightly greater than the thickness dimension of the bottom wall 24A. The second collar 28 is slightly protruded from the bottom wall 24A to the bracket 12 side, and contacts the upper wall 14 of the bracket 12.

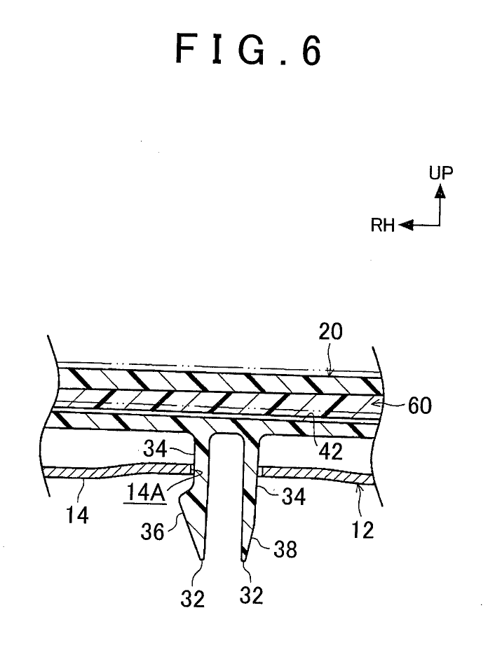

Then, bolts 30, as fastening members, are inserted through the first collar 26 and the second collar 28. The bolts 30 are screwed into the nuts 18 to fasten the mount 20 to the bracket 12 (see FIG. 6). Incidentally, a carpet C is disposed at the bracket 12 side of the mount 20. As the mount 20 is fastened to the bracket 12, the carpet C is clamped by a portion of a peripheral edge of the mount 20 and the bracket 12.

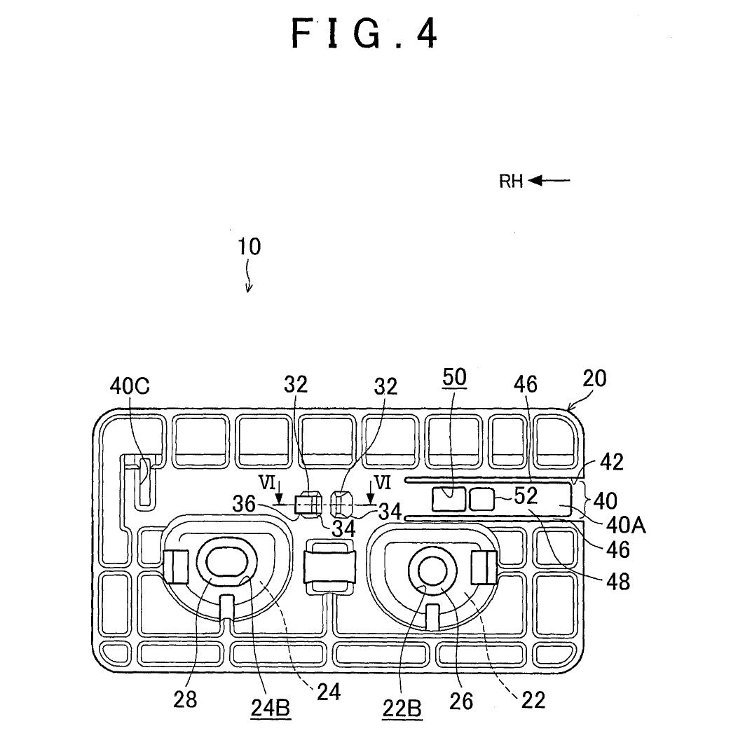

As shown in FIGS. 4 and 6, on a substantially central portion of the underneath surface of the mount 20 (the bracket 12-side surface of the mount 20), a pair of engagement claw portions 32 are provided integrally with the mount 20 as one unit. The engagement claw portions 32 are disposed facing each other in the vehicle width direction. Each engagement claw portion 32 has an engagement piece 34 of a generally rectangular platy shape. The engagement pieces 34 are projected from the mount 20 to the bracket 12 side. Furthermore, the engagement pieces 34 are constructed so as to be elastically deformable in the vehicle width. A distal end portion of the engagement claw portion 32 disposed at the right side of the vehicle is provided with a nail 36. The nail 36 has a generally triangular shape protruded to the right in a view from forward of the vehicle. Furthermore, a distal end portion of the engagement claw portion 32 disposed at the left side of the vehicle is provided with an inclined surface 38 that is inclined rightward of the vehicle toward the distal end of the engagement claw portion 32. The pair of engagement claw portions 32 are inserted in a generally rectangular positioning hole 14A that is formed in the bracket 12.

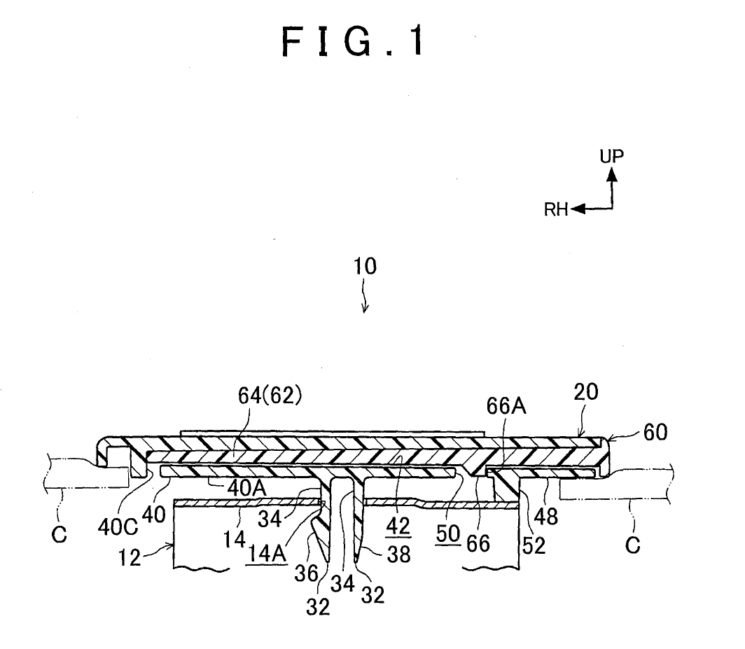

As shown in FIG. 1 and FIGS. 3 to 5, the mount 20 has a fitting portion 40 at a position in front of the pair of recess portions 22 and 24 with respect to the vehicle. When viewed from leftward of the vehicle, the fitting portion 40 has a generally rectangular annular shape a part of which is open to the vehicle cabin side (to the opposite side of the mount 20 to the floor F). Furthermore, the fitting portion 40 extends in the vehicle width direction from the vehicle left side end portion of the mount 20 to a little before the vehicle right side end portion of the mount 20. Thus, inside the fitting portion 40, a groove portion 42 having a rectangular shape in a side view extends in the vehicle width direction. Furthermore, the groove portion 42 is disposed so as to be inclined upward of the vehicle toward the front of the vehicle. Furthermore, the portion of the fitting portion 40 that is open is provided as an opening portion 44. The opening portion 44 communicates with an intermediate portion of the groove portion 42 in the width direction of the groove portion 42 in a view taken from a side of the vehicle. That is, the opening portion 44 communicates with the intermediate portion of the groove portion 42 in the vehicle longitudinal direction.

As shown in FIG. 4, a vehicle left side portion of a bottom wall 40A of the fitting portion 40 is provided with a pair of slits 46. The slits 46 extend in the vehicle width direction from a vehicle left side end portion of the fitting portion 40 to a little before an intermediate portion of the mount 20 in the vehicle width direction, and communicate with the groove portion 42. Thus, a portion between the pair of slits 46 is provided as a flexural portion 48. The flexural portion 48 is constructed so as to be flexible (elastically deformable) perpendicularly to the bottom wall 40A.

As also shown in FIG. 1, the flexural portion 48 of the fitting portion 40 is provided with an engagement hole 50 as an engagement portion. The engagement hole 50 is formed in a generally rectangular shape. Furthermore, the engagement hole 50 communicates with the groove portion 42. Further, the flexural portion 48 of the fitting portion 40 has a stopper portion 52 as a protrusion portion at a position to the vehicle left of the engagement hole 50. The stopper portion 52 is provided integrally together with the flexural portion 48. The stopper portion 52 is formed in a generally rectangular parallelepiped shape, and is protruded from the flexural portion 48 to the bracket 12 side. A distal end portion of the stopper portion 52 contacts the upper wall 14 of the bracket 12. Thus, the upper wall 14 of the bracket 12 serves as a “restraint portion” in the invention. Then, there is provided such a construction that as the stopper portion 52 contacts the upper wall 14, the engagement hole 50 is restrained from being displaced to the bracket 12 side. Incidentally, the stopper portion 52 may be provided so that a certain clearance is formed between the distal end of the stopper and the upper wall 14.

As shown in FIG. 3, the pedal 60 is manufactured from a resin (e.g., a thermoplastic polyester elastomer, for example, “Hytrel®” produced and sold by Toray-DuPont Co., Ltd.). The pedal 60 includes a support portion 62, a pad portion 70 and a hinge 72. The support portion 62 is supported by the mount 20. The pad portion 70 is formed in a generally rectangular platy shape, and is a portion to which depression force is applied. The hinge 72 links the pad portion 70 and the support portion 62.

The support portion 62 constitutes a lower portion of the pedal 60 with respect to the vehicle. Furthermore, the support portion 62 is elongated in the vehicle width direction. As shown in FIG. 5, a lower end portion of the support portion 62 is provided as a fitted portion 64 that is formed in a generally inverted T shape when reviewed from a side direction of the vehicle, that is, a view taken in the vehicle width direction. The fitted portion 64 is inserted into the groove portion 42 of the mount 20 and the opening portion 44 of the mount 20, and is fitted to the fitting portion 40 of the mount 20.

As shown in FIG. 1, a vehicle right side end portion of the fitted portion 64 contacts a right side wall 40C of the fitting portion 40 of the mount 20. This restricts the fitted portion 64 (pedal 60) from moving from the assembled position (the position shown in FIG. 1) toward the right side of the vehicle.

Furthermore, on a surface of the fitted portion 64 which faces the bottom wall 40A of the fitting portion 40, there is provided an engagement hook portion 66 having a generally trapezoidal shape in section as an engaged portion. The engagement hook portion 66 is protruded from the fitted portion 64 to the bottom wall 40A side, and is disposed in the engagement hole 50 of the mount 20. A vehicle left end surface of the engagement hook portion 66 is provided as a stop surface 66A. The stop surface 66A is disposed facing an inner peripheral surface of the engagement hole 50, and contacts the inner peripheral surface of the engagement hole 50. This restricts the fitted portion 64 (pedal 60) from moving from the assembled position toward the left of the vehicle.

As shown in FIGS. 3 and 5, the support portion 62 is provided with a generally rectangular platy flange portion 68 at a position upward from the fitting portion 40 with respect to the vehicle. The flange portion 68 is disposed facing the fitted portion 64. The flange portion 58 and the fitted portion 64 clamp the upper wall 40B of the fitting portion 40. Thus, the pedal 60 is supported by the mount 20.

As shown in FIGS. 2 and 3, the pad portion 70 is formed in a generally rectangular platy shape, and extends substantially in the vertical direction. A lower end portion of the pad portion 60 is disposed above the flange portion 68 of the support portion 62 with respect to the vehicle, and is linked to the support portion 62 by the hinge 72 (see FIG. 5). Thus, the pad portion 60 is pivotable about the hinge 72 serving as a support point. Therefore, as a driver depresses the pad portion 70, depressing force is applied to the pad portion 70.

Next, a procedure of assembling the mount 20 and the pedal 60 to the bracket 12 will be described and, at the same time, operation and effects of this embodiment will be described.

Firstly, when the pedal 60 is to be assembled to the mount 20, the fitted portion 64 of the pedal 60 is inserted into the groove portion 42 of the mount 20 from the left side of the mount 20 with respect to the vehicle. Then, the fitted portion 64 is slid to the right with respect to the vehicle. When the engagement hook portion 66 of the fitted portion 64 reaches the flexural portion 48 of the mount 20, the engagement hook portion 66 presses the bottom wall 40A of the fitting portion 40. Then, the flexural portion 48 flexes (elastically deforms) perpendicularly to the bottom wall 40A (in a direction away from the fitted portion 64). This allows the engagement hook portion 66 to be inserted into the groove portion 42. Then, as the fitted portion 64 is further slid rightward with respect to the vehicle, the right side end portion of the fitted portion 64 contacts the right side wall 40C of the fitting portion 40, and the engagement hook portion 66 of the fitted portion 64 is disposed in the engagement hole 50 of the fitting portion 40. Thus, the pedal 60 is assembled to the mount 20, so that the pedal 60 and the mount 20 form a subassembly.

Then, while the subassembly of the pedal 60 and the mount 20 is maintained as it is, the carpet C is disposed between the mount 20 and the bracket 12, and the pair of engagement claw portions 32 of the mount 20 are inserted into the positioning hole 14A of the bracket 12. At this time, if reaction force of the carpet C acts on the mount 20, the reaction force moves the mount 20 in a direction away from the bracket 12. However, since the nail 36 of the engagement claw portion 32 at the right side with respect to the vehicle is engaged with the inner peripheral surface of the positioning hole 14A, movement of the mount in a direction away from the bracket 12 is restrained.

Furthermore, the bolts 30 are inserted into the first collar 26 and the second collar 28, and are screwed into the nuts 18. Therefore, the mount 20 is fastened to the bracket 12. Thus, the mount 20 and the pedal 60 are assembled to the floor F of the vehicle via the bracket 12.

As described above, the mount 20 is provided with the fitting portion 40 that has therein the groove portion 42 and that extends in the vehicle width direction, and the fitting portion 40 is formed in an annular shape that is partially open to the vehicle cabin side. The fitted portion 64 of the pedal 60 is inserted into the groove portion 42 by sliding the fitted portion 64 toward the right side of the vehicle, so that the fitted portion 64 and the groove portion 42 are fitted to each other. Thus, the pedal 60 is supported by the mount 20, and there is no need to deform the fitting portion 40 so that the opening portion 44 opens (so that the upper walls 40B of the fitting portion 40 move apart from each other) when the fitted portion 64 is assembled to the groove portion 42.

Furthermore, the fitted portion 64 is provided with the engagement hook portion 66 that engages with the engagement hole 50 of the fitting portion 40. Then, the engagement hook portion 66 is engaged with the engagement hole 50 (i.e., the stop surface 66A of the engagement hook portion 66 contacts the inner peripheral surface of the engagement hole 50). This restricts movement of the fitting portion 64 toward the left side of the vehicle. Thus, this construction restrains the fitted portion 64 (pedal 60) from coming off from the fitting portion 40 (mount 20) toward the left side of the vehicle.

Furthermore, the upper wall 14 of the bracket 12 contacts the distal end of the stopper portion 52 of the mount 20. This restrains the engagement hole 50 from being displaced in a direction away from the fitted portion 64 (in a direction to the floor F side of the vehicle). Therefore, for example, if the engagement hole 50 (the flexural portion 48) should tend to be displaced in a direction away from the fitted portion 64 due to time-dependent changes of the mount 50 or the like, the upper wall 14 of the bracket 12 restrains displacement of the engagement hole 50. Therefore, the engagement between the engagement hole 50 and the engagement hook portion 66 is maintained. Thus, it is possible to restrain the pedal 60 from slipping off from the mount 20.

Besides, as described above, the upper wall 14 of the bracket 12 restrains displacement of the engagement hole 50 (the flexural portion 48), displacement of the engagement hole 50 can be restrained by utilizing the bracket 12. As a result, it is not necessary to separately provide a member that the stopper portion 52 of the mount 20 contacts. Therefore, a portion that is contacted by the stopper portion 52 of the mount 20 can be efficiently provided.

Furthermore, a sectional shape of the bracket 12 in a view taken in a sideways direction of the vehicle is a hat shape. Therefore, the stopper portion 52 of the mount 20 can be caused to contact the highly rigid bracket 12 so as to restrain displacement of the engagement hole 50.

Besides, the mount 20 is provided with the stopper portion 52. The stopper portion 52 is protruded toward the upper wall 14 side of the bracket 12, and is constructed so that the distal end of the stopper portion 52 is able to contact the upper wall 14. Therefore, by adjusting the amount of protrusion of the stopper portion 52, the mount 20 can be caused to contact the upper wall 14 in correspondence to the distance between the upper wall 14 and the mount 20.

Furthermore, the fitted portion 64 of the pedal 60 is inserted into the groove portion 42 by sliding the fitted portion 64 from the left side to the right side of the mount 20 with respect to the vehicle. That is, the pedal 60 is assembled to the mount 20 from the brake pedal side. Therefore, the direction in which a driver inputs force to the pedal 60 when the driver releases the brake pedal and depresses the pedal 60 can be made substantially equal to the direction in which the pedal 60 is assembled to the mount 20. This restrains the pedal from slipping off from the mount 20 due to the force input to the pedal 60 from the driver when the driver releases the brake pedal and immediately depresses the pedal 60.

Furthermore, the mount 20 is provided with the pair of engagement claw portions 32, and the engagement claw portions 32 are inserted into the positioning hole 14A of the bracket 12. Therefore, the engagement claw portion 32 serves as a positioning portion for the mount 20 when the mount 20 is assembled to the bracket 12. Furthermore, when the mount 20 is assembled to the bracket 12, the reaction force from the carpet C acts on the mount 20. However, the engagement claw portion 32 at the right side with respect to the vehicle is provided with the nail 36. Therefore, when the mount 20 is moved in a direction away from the bracket 12, the nail 36 of the engagement claw portion 32 engages with the inner peripheral surface of the positioning hole 14A. Hence, movement of the mount 20 in a direction away from the bracket 12 is restrained. This restrains the mount 20 from being lifted when the bracket 12 is assembled to the mount 20. Therefore, the ease of assembling the mount 20 to the bracket 12 can be improved.

Furthermore, the mount 20 is fastened to the bracket 12 by the pair of bolts 30. Therefore, when the mount 20 is fastened to the bracket 12, the mount 20 can be fastened to the bracket 12 while rotation of the mount 20 with respect to the bracket 12 is restrained. Therefore, the ease of assembling the mount 20 to the bracket 12 can be further improved. Furthermore, for example, the mount 20 can be more easily removed from the bracket than, for example, in the case where the mount 20 is provided with a nail or claw and the nail or claw is fitted to the bracket 12 to fasten the mount 20 to the bracket 12. This allows reuse of the mount 20 and the pedal 60.

Furthermore, the mount 20 and the pedal 60 are constructed as separate members. Therefore, for example, by manufacturing the mount 20 from a resin that contains glass fiber, the mount 20 can be constructed as a component part that is relatively high in strength. This effectively improves the ease of assembling the mount 20 to the bracket 12.

Incidentally, in the embodiment, the engagement hole 50 of the mount 20 extends through the bottom wall 40A of the fitting portion 40, and communicates with the groove portion 42. Instead of this construction, an engagement hole 50 may be formed in a bottomed recess portion that is protruded to the bracket 12 side.

Furthermore, in the embodiment, the fitted portion 64 of the pedal 60 is provided with the engagement hook portion 66, and the engagement hook portion 66 is disposed in the engagement hole 50 of the mount 20. Instead of this construction, the engagement hook portion 66 may be formed on the fitting portion 40 of the mount 20. Then, an engagement hole 50 is formed in the fitted portion 64 of the pedal 60. In this manner, the engagement hook portion 66 may be disposed within the engagement hole 50. In this case, the engagement hook portion 66 is provided as an “engagement portion” in the invention, and the engagement hole 50 is provided as an “engaged portion” in the invention.

Furthermore, although in the embodiment, the opening portion 44 of the mount 20 communicates with the intermediate portion of the groove portion 42 of the mount 20 in the direction of the width of the groove 42 when reviewed from a side direction of the vehicle, the position of the opening portion 44 of the mount 20 can be arbitrarily set in the width direction of the groove portion 42 of the mount 20. For example, the opening portion 44 of the mount 20 may be disposed so as to communicate with an end portion of the groove portion 42 of the mount 20 in the width direction of the groove portion when reviewed from a side direction of the vehicle. In this case, the fitting portion 40 of the pedal 60 is formed in a generally L shape in when reviewed in a side direction of the vehicle.

Besides, in the embodiment, as the distal end of the stopper portion 52 of the mount 20 contacts the upper wall 14 of the bracket 12, displacement of the engagement hole 50 is restrained. However, instead of this construction, a separate member constructed so as to be able to contact the distal end of the stopper portion 52 of the mount 20 may be fixed to the floor F of the vehicle.

Furthermore, although in the embodiment, the stopper portion 52 of the mount 20 is disposed to the left of the engagement hole 50 with respect to the vehicle, the position of the stopper portion 52 can be arbitrarily set. That is, it suffices that the stopper portion 52 is able contact the upper wall 14 of the bracket 12 so that displacement of the engagement hole 50 can be restrained.

Furthermore, although in the embodiment, of the pair of engagement claw portions 32 of the mount 20, only the engagement claw portion 32 at the right side with respect to the vehicle is provided with the nail 36, the nail 36 may be provided on each of the two engagement claw portions 32.

Furthermore, although in the embodiment, the mount 20 is fastened to the bracket 12 by the pair of bolts 30, more than pair of bolts 30 may also be used to fasten the mount 20 to the bracket 12.

While the disclosure has been explained in conjunction with specific exemplary embodiments thereof, it is evident that many alternatives, modifications, and variations will be apparent to those skilled in the art. Accordingly, exemplary embodiments of the disclosure as set forth herein are intended to be illustrative, not limiting. There are changes that may be made without departing from the scope of the disclosure.

1. An accelerator pedal device comprising:
a bracket provided on a floor on which a driver's seat of a vehicle is disposed;
a mount including a fitting portion extending in a vehicle width direction and having an annular shape a part of which is open when viewed from a side direction of the vehicle, and a first engagement portion provided in the fitting portion, and the mount being assembled to the bracket;
a pedal including a fitted portion that is fitted to the fitting portion by sliding the fitted portion toward one side in the vehicle width direction, and an engaged portion that is provided in the fitted portion and that restricts movement of the fitted portion toward another side in the vehicle width direction by engaging with the first engagement portion, the pedal being applied with depression force; and
a restraint portion that contacts the fitting portion and restrains the first engagement portion from being displaced in a direction away from the fitted portion.

2. The accelerator pedal device according to claim 1, wherein the restraint portion is provided on the bracket.

3. The accelerator pedal device according to claim 2, wherein
the bracket has a hat shape in a cross section when viewed from a side direction of the vehicle.

4. The accelerator pedal device according to claim 2, further comprising
a protrusion portion that is provided on the mount and is protruded toward the restraint portion and that is configured to be able to contact the restraint portion.

5. The accelerator pedal device according to claim 4, wherein
the protrusion portion is provided on the fitting portion.

6. The accelerator pedal device according to claim 1, wherein
the fitting portion includes a contact portion that contacts an end portion of the fitted portion which is at the one side in the vehicle width direction, and the one side in the vehicle width direction is rightward with respect to the vehicle.

7. The accelerator pedal device according to claim 1, further comprising
a second engagement portion provided on the mount and configured to be able to engage with the bracket.

8. The accelerator pedal device according to claim 7, wherein
the second engagement portion includes a claw portion that is able to engage with the bracket when inserted in the bracket.

9. The accelerator pedal device according to claim 1, wherein
the mount is fastened to the bracket by at least two fastening members.
